(19) United States
(12) Patent Application Publication
(10) Pub. No.: US 2025/0014130 A1
(43) Pub. Date: Jan. 9, 2025

(54) Logo detection, protection and content monetization system

(71) Applicant: Stuart Byron Booker, Henderson, NV (US)

(72) Inventor: Stuart Byron Booker, Henderson, NV (US)

(21) Appl. No.: 18/219,647

(22) Filed: Jul. 8, 2023

(51) Int. Cl. G06Q 50/18; G06V 20/40

(52) U.S. Cl. CPC G06Q 50/184; G06V 20/41; G06Q 20/1235; G06V 2201/09

(57) ABSTRACT

A method relates to a kind of novel approach for the utilization of API systems focused on cultivating robust systems around validating, retrieving, monetizing, and verifying logos to avoid scams, fraud, and illegal use of artwork.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates generally to images and more particularly relates to electronic image object or logo recognition.

### Description of the Related Art

It is common for digital video content, such as television (TV), movies, games, videos, etc., to include a logo, a title, or a sub-title. For example, many TV broadcasts include the logo of the broadcasting network or station in a portion of the video frame. In some cases, the logo may be semi-transparent. In other cases, the logo may be solid and not transparent. The logo often remains in the video frames being displayed throughout an entire program, or even continuously for all programs on a network or channel. Similarly, titles and sub-titles may be included in video frames to convey information to the viewer. In some cases, advertising is also included in the video frames in a manner similar to a logo. Logo, title, and sub-title detection is a common task in video editing operations. However, the detection is typically done as part of off-line processing of the video frames in order to remove the logo or to identify advertising segments. Additionally, current techniques for logo detection are inefficient and slow.

By looking at prior art multiple inventions have been seen in similar regards. For instance, a US patent System and method for facilitating logo-recognition training of a recognition model. In certain embodiments, training of a prediction model (e.g., recognition or other prediction model) may be facilitated via a training set generated based on one or more logos or other graphics. In some embodiments, graphics information associated with a logo or graphic (e.g., to be recognized via a recognition model) may be obtained. Training media items (e.g., images, videos, etc.) may be generated based on the graphics information, where each of the training media items includes (i) content other than the logo and (ii) a given representation of the logo integrated with the other content. The training media items may be processed via the recognition model to generate predictions (related to recognition of the logo or graphic for the training media items). The recognition model may be updated based on (i) the generated predictions and (ii) corresponding reference indications (related to recognition of the logo for the training media items).

An EP U.S. Pat. No. 2,259,207A1 relates to method of detection and recognition of logos in a video data stream. The present invention relates to a method of detection and recognition of logos in a video data stream comprising the steps of sampling (1) frames of said video data stream; segmenting (3) regular shapes such as, for example, circles, ellipses and rectangles; generating (4) a vector of feature parameters of an image contained in each of said shapes; and comparing said feature parameters with a database for determining (5) whether the images correspond to logos. The frames are captured preferably using a sampling frequency which is dynamically adapted to processing times, for the purpose of allowing the system to work in real time.

A U.S. Pat. No. 9,508,021B2 relates to a method of detection and recognition of logos in a video data stream comprising the steps of sampling (1) frames of said video data stream; segmenting (3) regular shapes such as, for example, circles, ellipses and rectangles; generating (4) a vector of feature parameters of an image contained in each of said shapes; and comparing said feature parameters with a database for determining (5) whether the images correspond to logos. The frames are captured preferably using a sampling frequency which is dynamically adapted to processing times, for the purpose of allowing the system to work in real time.

A U.S. Pat. No. 2,012,0177249A1 relates to method of detecting logos, titles, or sub-titles in video frames. Detecting a static graphic object (such as a logo, title, or sub-title) in a sequence of video frames may be accomplished by analyzing each selected one of a plurality of pixels in a video frame of the sequence of video frames. Basic conditions for the selected pixel may be tested to determine whether the selected pixel is a static pixel. When the selected pixel is a static pixel, a static similarity measure and a forward motion similarity measure may be determined for the selected pixel. A temporal score for the selected pixel may be determined based at least in part on the similarity measures. Finally, a static graphic object decision for the selected pixel may be made based at least in part on the temporal score.

By looking at prior art, multiple inventions have been seen, However, these solutions are limited and restricted to their conventional problems as discussed above. Legitimacy is one of the big issues as nothing prevents an impostor from “tokenizing” and selling someone else's invention, while the creator remains oblivious to the fraud. With the current state of affairs, the use of copyrighted videos is greatly discouraged and real rights owners want means to get credit of their work. The current invention relates to a method for finding logos in video and notifying the brand owner, while giving them the option of requesting that the logo be blurred from the video, kept as is in the video, charge the video owner a fee, and or able to pay the video owner a fee to be displayed in the video for a fee once the video reaches a minimum viewership. The proposed system supports video licensing, authentication, and royalties.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved method for securely designed applications that ensures a system and method for finding logos in videos.

It is also the primary objective of the invention to provide a smart methodology directed to devices, systems, and methods for facilitating a non-custodial, decentralized platform allowing to authenticate and notify the brand owner.

It is another objective of the invention to provide a system providing real-world use-case providing the brand owners the option of requesting that the logo be blurred from the video, kept as is in the video, charge the video owner a fee, and or able to pay the video owner a fee to be displayed in the video for a fee once the video reaches a minimum viewership.

It is also the object of the invention to provide an advanced system that provides a secure environment and offers content creators to get paid on product placement after they have already distributed their video and are not required to cover up the brand logo during or after film production.

It is a further objective of the invention to provide a method for video rights registration and authentication that will provide an incentive to content creators to put brands in their videos for the opportunity to get paid in the future rather than upfront before production starts.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates the complete view of the payment method module, in accordance with an embodiment of the present disclosure;

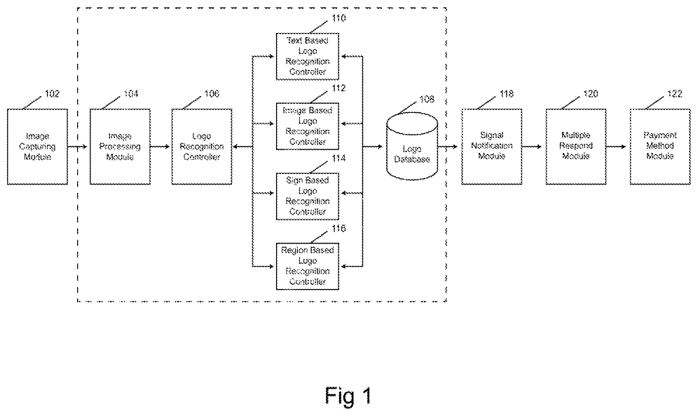

FIG. 2 illustrates view of the payment options and when the logo is recognized and processed;

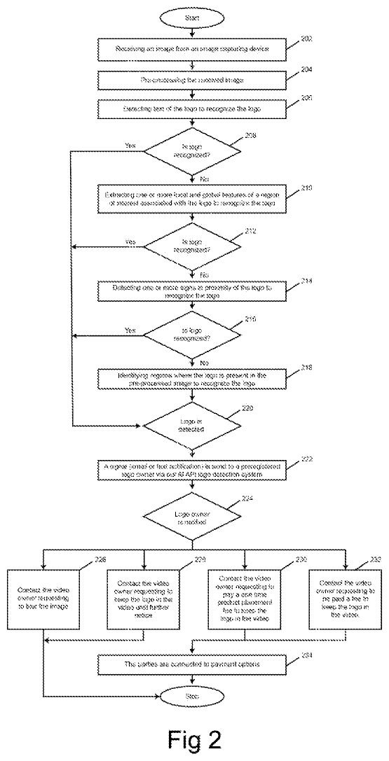

FIG. 2A illustrates another view of the invention logo is processed;

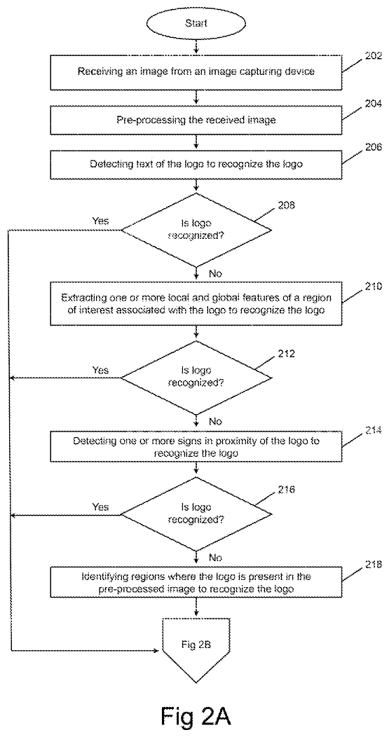

FIG. 2B illustrates another view of the invention payment options;

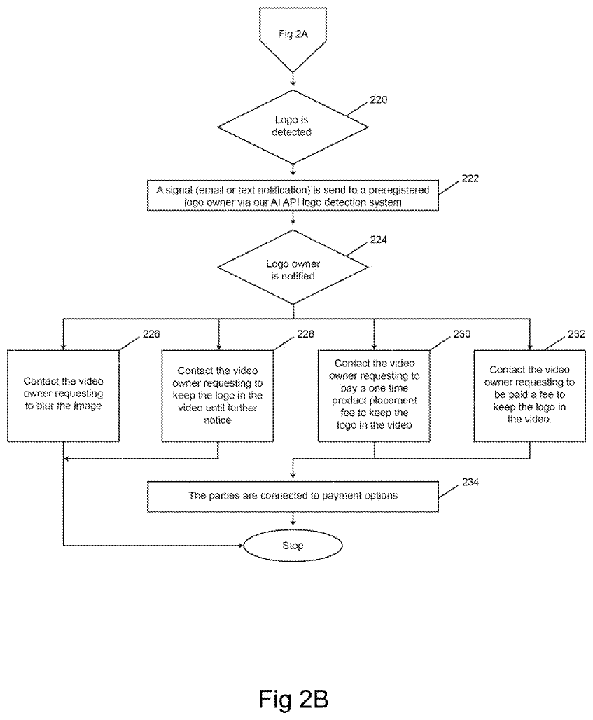

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced platform allowing three methods and steps; to authenticate of the ownership and authenticity of logos wherein the process involves finding logos in video, notifying the brand owner, and giving them the option of requesting that the logo be blurred from the video, kept as is in the video, charge the video owner a fee, and or able to pay the video owner a fee to be displayed in the video for a fee once the video reaches a minimum viewership.

As per its preferred embodiments, the system involves an AI-powered API to detect logos in prerecorded and live videos, a notification system that will alert the brand owners of their logos being displayed in a video, a system in which content creators can agree to a set fee and or variable rate for compensation if they are contacted by the brand that they want to keep their brand in the video, a video streaming platform in which to play videos, a payment system in which to pay the product placement fee to the video rights holder or charge them as well.

The technology as per its additional embodiments also proposes an electronic device for the implementation of the system including:
a memory device; and, software for the system and method;
a memory for storing machine-executable instructions; and,
a backend database server
   wherein, by reading and executing machine-executable instructions stored by the memory corresponding to control logic based on authentication. In some embodiments, the processing system device is configured to execute computer-readable program code further to manage the detection and authentication system. A computing device may comprise one or more processors, for example, to execute an application or other code. For example, among other things, an application may perform the process described above. In a particular implementation, the computing system may perform a cascaded process, wherein the cascaded process comprises comparing points extracted from a sample image to elements of a primary index, and querying a secondary index if the points correspond to elements of the primary index. In another particular implementation, the computing system may comprise a special purpose computing system to receive electronic signals representing an image, transform electronic signals to encode a geometric structure of local descriptors of an object in the image, and identify the object based, at least in part, on logo-classes generated from multiple training images.

A computing device may be representative of any device, appliance, or machine that may be employed to manage memory devices. The memory device may include a memory controller and a memory. By way of example, but not limitation, the computing device may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or information storage service provider or system; or any combination thereof.

All or part of various devices shown in the system, or processes and methods described herein, may be implemented using or otherwise including hardware, firmware, software, or any combination thereof (although this is not intended to refer to software per se). Thus, by way of example, but not limited, computing devices may include at least one processing unit that is operatively coupled to memory via a bus and memory controller. The processing unit is representative of one or more circuits to perform at least a portion of an information-computing procedure or process. For example, a process to identify an object such as a logo may include quantizing image descriptors for a particular image, searching for matches between selected groups of the quantized image descriptors and groups in a group index of a collection of logos, and, if matches occur, searching for further matches between larger groups of the quantized image descriptors and polygons in a polygon index of the collection of logos. Larger groups may include matched selected groups, for example.

By way of example but not limitation, a processing unit may include one or more processors, controllers, microprocessors, microcontrollers, application-specific integrated circuits, digital signal processors, programmable logic devices, field programmable gate arrays, or the like, or any combination thereof. The processing unit may include an operating system to communicate with the memory controller. An operating system may, for example, generate commands to be sent to the memory controller over or via bus. Commands may comprise read or write commands, for example. Memory is representative of any information storage mechanism. The memory may include, for example, a primary memory or a secondary memory. Primary memory may include, for example, random-access memory, read-only memory, etc. While illustrated in this example as being separate from the processing unit, it should be understood that all or part of primary memory may be provided within or otherwise co-located/coupled with the processing unit.

The secondary memory may include, for example, the same or similar type of memory as primary memory or one or more information storage devices or systems, such as, for example, a disk drive, an optical disc drive, a tape drive, a solid state memory drive, etc. In certain implementations, secondary memory may be operatively receptive of, or otherwise able to couple to, a computer-readable medium. The computer-readable medium may include, for example, any medium able to carry or make accessible signal information, code, or instructions for one or more devices, such as in system.

Computing device may include, for example, an input/output. Input/output is representative of one or more devices or features able to accept or otherwise introduce human or machine-produced signal inputs, or one or more devices or features able to deliver or provide human or machine-comprehendible signal outputs. By way of example but not limitation, input/output device may include a display, speaker, keyboard, mouse, trackball, touch screen, signal port, etc.

It will, of course, be understood that, although particular embodiments have just been described, claimed subject matter is not limited in scope to a particular embodiment or implementation. For example, one embodiment may be in hardware, such as implemented on a device or combination of devices, for example. Likewise, although claimed subject matter is not limited in scope in this respect, one embodiment may comprise one or more articles, such as a storage medium or storage media that may have stored thereon instructions capable of being executed by a specific or special purpose system or apparatus, for example, to result in performance of an embodiment of a method in accordance with claimed subject matter, such as one of the embodiments previously described, for example. However, claimed subject matter is, of course, not limited to one of the embodiments described necessarily. Furthermore, a specific or special purpose computing platform may include one or more processing units or processors, one or more input/output devices, such as a display, a keyboard or a mouse, or one or more memories, such as static random access memory, dynamic random access memory, flash memory, or a hard drive, although, again, claimed subject matter is not limited in scope to this example.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice-versa. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A system for logo detection, protection, and content monetization, comprising:
a memory device; and, software for the system and method;
a backend database server; and,
a processing device and software operatively coupled to the memory device, wherein the processing device and software is configured to execute computer-readable program code to provide:
The system for logo detection, protection, and content monetization as per claim 1, wherein the video is uploaded onto a video streaming platform.
The system for logo detection, protection, and content monetization as per claim 1, wherein the API detects a logo is in a video.
The system for logo detection, protection, and content monetization as per claim 1, wherein the brand owner of the logo is notified that the video rights owner has said logo in their video and that the video has received a certain number of views over a given period.
The system for logo detection, protection, and content monetization as per claim 1, wherein the brand owner is given a variety of options.
The system for logo detection, protection, and content monetization as per claim 1, wherein the option includes keeping the logo in the video as is or Blur the logo or requesting to be paid a fee to keep the logo in the video or pay a fixed or variable fee to the video owner to keep the logo in the video.
